(19) United States
(12) Patent Application Publication
(10) Pub. No.: US 2010/0213116 A1
(43) Pub. Date: Aug. 26, 2010

(54) ANTI-SCALE BAG

(76) Inventor: Giorgio Del Frate, Porto San Giorgio (IT)

Correspondence Address: Hodes, Pessin & Katz, 901 Dulaney Valley Road, Suite 400, Towson, MD, 21204, US

(21) Appl. No.: 12/734,022

(22) PCT Filed: Oct. 7, 2008
(86) PCT No.: PCT/EP2008/063385

§ 371 Date: Apr. 5, 2010

(30) Foreign Application Priority Data
Oct. 8, 2007 (IT) MC2007A000193

(51) Int. Cl. C02F 5/00; C02F 1/42

(52) U.S. Cl. 210/282

(57) ABSTRACT

The present invention relates to an anti-scale bag (S) for washing machines, which contains resins with ion exchange (2) and can be reused for a high number of washing cycles.

The present patent application relates to a bag used to prevent the formation of scale in washing machines during ordinary washing cycles.

In spite of large popularity of washing machines, their functional efficacy and duration are considerably impaired by the formation of scale in the appliance.

Scale builds up on the walls of hoses and heating elements every time laundry is washed, creating high load losses that reduce the efficiency and reliability of the appliance over time.

In the presence of scale, washing machines do not operate correctly and risk to get blocked, since the layer of scale formed in the hoses and heating elements responsible for water heating acts as insulation, requiring a longer time to heat water and consequently damaging mechanical parts.

Moreover, in case of hot water, scale causes high energy waste and inefficiency of the installation due to high heat resistance (thermal insulation) and encrusts the drum of the washing machine.

Moreover, the holes of the drum can be partially or totally clogged by the scale, so that higher doses of detergent must be used to obtain the same washing result.

For the aforementioned reason, decalcifying products must be added to washing water in order to extend the life of the washing machine as much as possible.

Numerous types of products are available on the market, either in liquid or solid state, such as pills or powders, which must be used at every washing cycle in order to prevent the formation of scale with consequent damages.

The inconvenience of these products consists in the method of use, which imposes constant repetitive application at every washing cycle, thus forcing the user to buy the most suitable product on a periodical basis, with the risk of having to use the washing machine without the anti-scale product until the same is purchased again.

The purpose of the present invention is to obtain a device that can be used for multiple washing cycles to avoid the formation and build-up of scale in a washing machine.

Another purpose of the present invention is to obtain a device that is cheaper to use compared to the currently available anti-scale products, with the same level of efficacy and reliability.

These and other purposes have been achieved by the device of the invention, whose main characteristics are illustrated in the first claim.

The device of the invention consists in a bag made of a highly transpirating fabric that contains strong cathionic resins in granular form.

The said bag must be inserted inside the washing machine together with the laundry to be washed, so that water can pass through the external fabric and come in contact with the said resins, which perform a ion exchange with water.

The particles of the water used for washing are rich in calcium and magnesium salts and the ion exchange allows to reduce or eliminate the amount of scale contained in the washing water.

The resins with ion exchange are composed of a polymeric matrix, normally in granular form, where the ions available for the ion exchange are trapped or incorporated.

In order to facilitate the reflow of water particles inside the bag, an internal spongy body is provided to absorb the water outside the bag, which passes through the cathionic resins, is depurated of calcium and magnesium salts and finally flows out of the bag.

The water inflow and outflow are facilitated by the centrifugation and continuous compression suffered by the bag during ordinary washing cycles because of the movement determined by centrifugation, being contained inside the drum together with the dirty laundry.

Because of the capacity of the bag of the invention to trap salts, the bag must be washed after use, immersed in a regenerative brine (water+salt), drained and wrung, before being used again.

Evidently, according to the quantity and quality of the cathionic resins, the number of uses the bag of the invention can be higher or lower, since there are some resins that maintain their properties for 10 years.

For major clarity, the description of the bag of the invention continues with reference to the enclosed drawing, which has a merely illustrative, not limiting value, wherein:

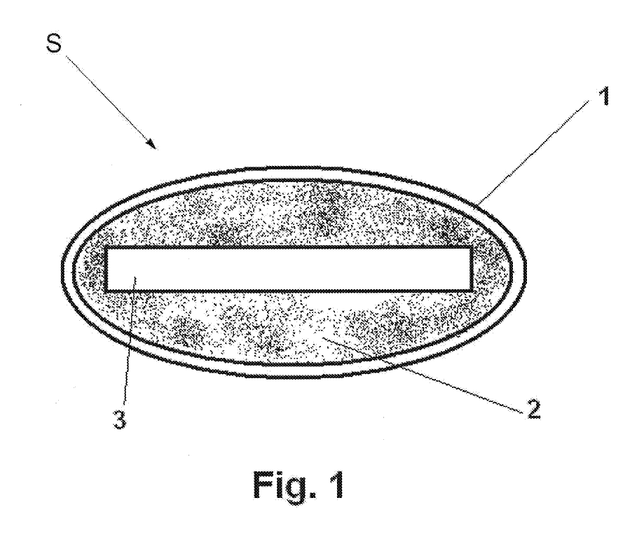

FIG. 1 is a diagrammatic sectional view of the bag of the invention with a vertical plane.

With reference to FIG. 1, the bag (S) of the invention is made of a water permeable fabric (1) and contains cathionic resins in granular form (2) that surround a central spongy body (3).

According to a preferred embodiment, the bag of the invention is as shown in FIG. 1 and as described above, although it may be not provided with the internal spongy body (3), which in any case increases the efficacy of the water flow inside the bag (S).

1. Bag (S) designed to prevent the formation of scale in washing machines, said bag (S) being made of water permeable fabric (1) and containing resins with ion exchange (2), characterized in that the bag (S) contains a single central spongy body (3) wherein the resin (2) surround the central spongy body (3).

2. Bag (S) as claimed in claim 1, wherein the resins (2) are cathionic resins.

3. Bag (S) as claimed in claim 2, wherein the resins (2) are strong cathionic resins.

4. Bag (S) as claimed in claim 3, wherein the strong cathionic resins (2) are in granular form.

5. (canceled)
